(19) United States
(12) Patent Application Publication
(10) Pub. No.: US 2003/0184916 A1
(43) Pub. Date: Oct. 2, 2003

(54) Air bearing slider having textured contact region to provide a self-adjusting fly height interface

(76) Inventors: Jorge V. Hanchi, St. Louis Park, MN (US); Zine-Eddine Boutaghou, Vadnais Heights, MN (US)

Correspondence Address: Deirdre Megley Kvale, Westman, Champlin & Kelly, Suite 1600, International Centre, 900 Second Avenue South, Minneapolis, MN, 55402-3319, US

(21) Appl. No.: 10/227,063

(22) Filed: Aug. 23, 2002

Related U.S. Application Data
(60) Provisional application No. 60/367,670, filed on Mar. 26, 2002.

(51) Int. Cl. G11B 5/60

(52) U.S. Cl. 360/236.5

(57) ABSTRACT

A head for a data storage device including a textured close point or transition region having a suitable wear rate to provide a self-adjusting fly height interface. The textured transition enables transition to a fly regime of operation for a contact regime slider to limit head crash or loss.

### CROSS-REFERENCE TO RELATED APPLICATION

This application claims priority from U.S. Provisional Application 60/367,670 filed on Mar. 26, 2002 and entitled “SELF-ADJUSTING FLY HEIGHT SLIDERS FOR NEAR-CONTACT RECORDING DISC FILES”.

### FIELD OF THE INVENTION

The present invention relates generally to data storage devices, and more particularly but not by limitation to a head for a data storage device.

### BACKGROUND OF THE INVENTION

Data storage devices store digital information on a disc or storage media. Heads read data from or write data to the data storage disc. Heads include transducer elements, such inductive, magneto-resistive and magneto-optical transducer elements for read-write operations. Heads are coupled to an actuator assembly via a head suspension assembly and the actuator assembly is energized to position the heads relative to selected data tracks for read-write operations. The head suspension assembly includes a load beam which supplies a load force to the head at a load or gimbal point. The head is coupled to the suspension assembly or load beam through a gimbal spring so that the head pitch and rolls relative to the load or gimbal point to follow the contour of the disc or data storage surface.

Transducer elements of the head are carried on a trailing edge of an air bearing slider for proximity, near proximity or near contact recording. The air bearing slider includes at least one raised bearing surface and at least one recessed bearing surface. Rotation of the disc or storage medium provides an air flow along the air bearing surface of the slider to provide a hydrodynamic lifting force which is countered by the load force to define in part a fly height for the slider for read-write operations. Areal disc drive density is increasing requiring lower fly heights or head-disc spacing between the transducer elements carried by the slider and the disc surface for desired read-write resolution and clarity.

Heads are fabricated by a wafer fabrication process. Transducer elements and layers are fabricated on the wafer to form the transducer portion of the air bearing slider having embedded transducer elements. Individual sliders are diced from the wafer and lapped to provide a desired throat height or dimension for desired head-disc spacing for the transducer elements and the heads are coupled to the gimbal spring to form a head gimbal assembly.

For manufacturing process control purposes, head gimbal assemblies are fly and electrically tested. The testing operation involves rotating a disc to provide an air flow along the air bearing surface of the slider to gauge the flying height as well as to assess the electrical integrity of the recording head. A given population of manufactured head-gimbal assemblies includes heads having flying heights below a glide avalanche height of the disc. Such head gimbal assemblies are said to operate under interference contact conditions or, equivalently to operate in a contact regime of operation. Operation of a recording head in the contact regime leads to catastrophic tribological failure or a head crash, which limits the use of such heads and thus reduced manufacturing yield. Embodiments of the present invention provide solutions to these and other problems, and offer other advantages over the prior art.

### SUMMARY OF THE INVENTION

The present invention relates to a head for a data storage device including a textured close point or transition region having a suitable wear rate to provide a self-adjusting fly height interface. The textured transition region provides a fly height transition for a contact regime slider to limit head crash and increase manufacturing yield. Other features and benefits that characterize embodiments of the present invention will be apparent upon reading the following detailed description and review of the associated drawings.

### BRIEF DESCRIPTION OF THE DRAWINGS

FIG. 1 is perspective illustration of a data storage device.

FIG. 2 is an elevational illustration of a head suspension assembly.

FIG. 3 is an illustration of a head gimbal assembly.

FIG. 4 is a detailed illustration of head disc interface between a transducer portion of the slider and a disc surface.

FIG. 5 diagrammatically illustrates an air bearing slider having a positive static roll attitude or negative static roll attitude.

FIG. 6 graphically illustrates a fly height distribution for a manufactured or tested lot of head gimbal assemblies.

FIGS. 7-8 schematically illustrate an embodiment of a slider including a transducer portion and textured fly height transition region.

FIG. 9 illustrates wear of the textured transition region to burnish the head for transition from a contact regime to a fly height regime.

FIGS. 10-11 schematically illustrate another embodiment of a slider including a transducer portion and textured fly height transition region.

FIG. 12 is a detailed illustration of a textured structure including a plurality of micro-textured bumps or projections.

FIG. 13 is a schematic profile illustration of textured bumps or projections for a textured fly height transition region.

FIG. 14 illustrates interface friction and head crash for a slider without a textured fly height transition region.

FIG. 15 illustrates a transition from a contact regime to a fly height regime for a slider including a textured fly height transition region.

FIG. 16 illustrates a transducer signal for a contact regime head.

FIG. 17 illustrates a transducer signal for a transitioned head in a fly height regime.

### DETAILED DESCRIPTION OF ILLUSTRATIVE EMBODIMENTS

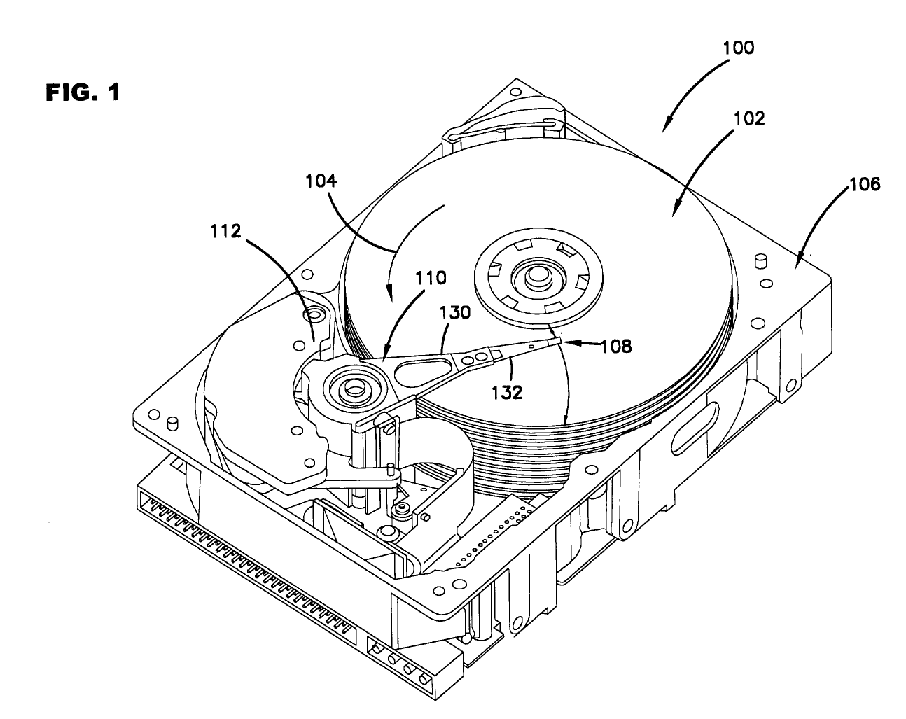

FIG. 1 is a perspective illustration of an embodiment of a data storage device 100 in which embodiments of the present invention are useful. Device 100 includes at least one data storage disc 102 rotationally (as illustrated by arrow 104) coupled to a base chassis 106 by a spindle motor (not shown). Heads 108 are coupled to an actuator assembly 110 as shown. A voice coil motor 112 is coupled to the actuator assembly 110 and is operational to position the heads 108 relative to selected data tracks on the disc surface for read-write operations through interface with a host system (not shown).

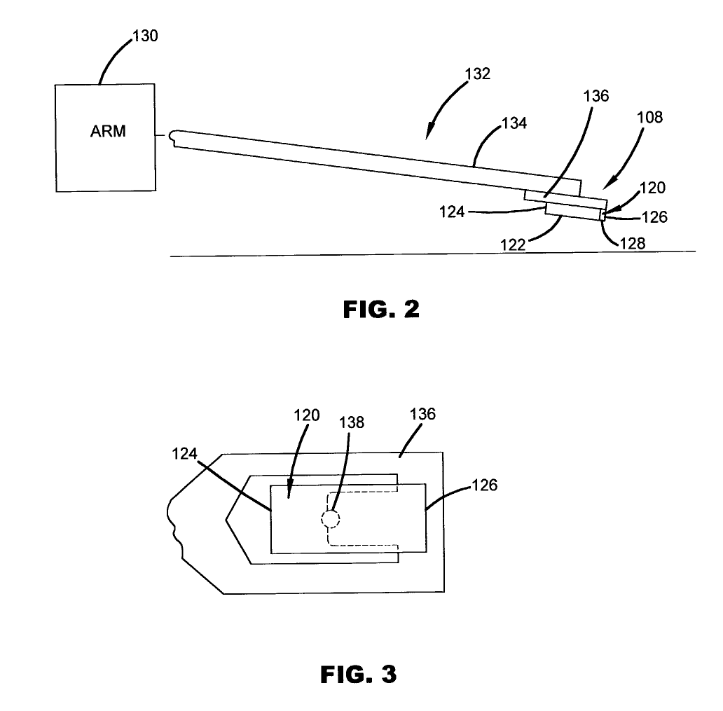

The head 108 includes a slider 120 having an air bearing surface 122, a leading edge 124 and a trailing edge 126 as shown in FIG. 2. Rotation of the disc provides an air flow along the air bearing surface 122 of the slider from the leading edge 124 to the trailing edge 126 for hydrodynamic operation. In the illustrated embodiment, transducer elements 128 (illustrated schematically) are fabricated proximate to the trailing edge 126 of the slider 120. Transducer elements include, but are not limited to inductive, magneto-resistive, tunneling magneto-resistive and magneto-optical transducer elements.

As shown in FIG. 2, heads 108 are coupled to an actuator arm 130 of the actuator assembly 110 through a head suspension assembly 132 including a load beam 134 and a gimbal spring 136. As shown, the load beam is adapted to supply a load force to the slider 120 at a load point 138 (shown in FIG. 3) which is opposed to a hydrodynamic lifting force of the air bearing surface 122 of the slider 120 to define in part a fly height for the slider above the disc surface. The slider is flexibly supported relative to the gimbal spring 136 to pitch and roll relative to the gimbal or load point 138 to follow the contour of the disc surface for read-write operations.

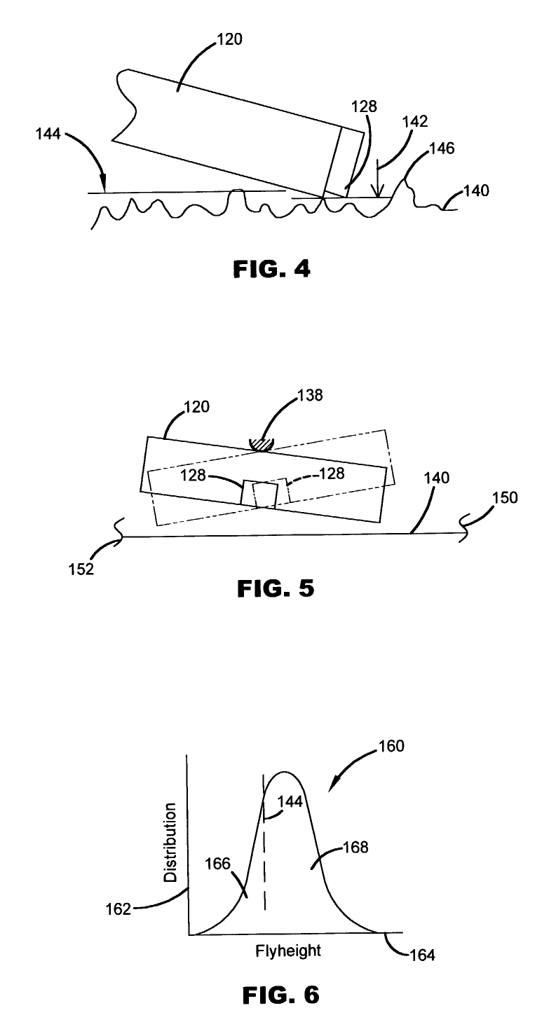

As illustrated in greater detail in FIG. 4, for hydrodynamic operation, transducer elements 128 are spaced from the disc surface 140 to provide a head-disc spacing 142 between the transducer elements 128 and the disc surface 140 for read-write operations. Areal disc drive density is increasing reducing head-disc spacing parameters for desired read-write resolution and clarity. For operation the slider 120 must fly above a glide avalanche height 144 of the disc which is a function of the surface contour of the disc surface. Below the glide avalanche height 144, the slider will have massive contacts with the disc surface.

As shown, discs include asperities 146 on the disc surface. Contact between asperities 146 on the disc surface and the slider 120 or transducer element 128 can damage the head and can cause thermal asperities for a magneto-resistive transducer element. In particular, contact between the transducer element and the disc surface can generate heat which can damage the magneto-resistive elements. As shown in FIG. 5, a head suspension or gimbal assembly is fabricated to provide a positive static roll attitude for the head towards an inner diameter 150 or negative static roll attitude for the head (shown in dashed lines) towards an outer diameter 152 of the disc to shift the contact point or close point away from the transducer elements to protect the transducer elements from head-disc contact.

Heads are typically fabricated by a wafer fabrication process. Heads are assembled to form a head gimbal assembly. The head gimbal assembly is tested to test electrical integrity and fly height interface of the head. FIG. 6 illustrates a fly height test distribution 160 for tested head gimbal assemblies. As illustrated in FIG. 6, a number distribution 162 for a range of fly heights illustrated by axis 164 is shown. As shown in FIG. 6, some of the assemblies have a fly height below the glide avalanche height 144 of the disc and operate in a contact regime 166. Operation of the head in the contact regime 166 leads to head crash or failure. The present invention relates to a slider having a self adjusting transition region or interface to transition the slider from the contact regime 166 to a fly height regime 168 for desired read-write operation and has particular application for a magneto-resistive head operating in the sub 10 nm fly regime.

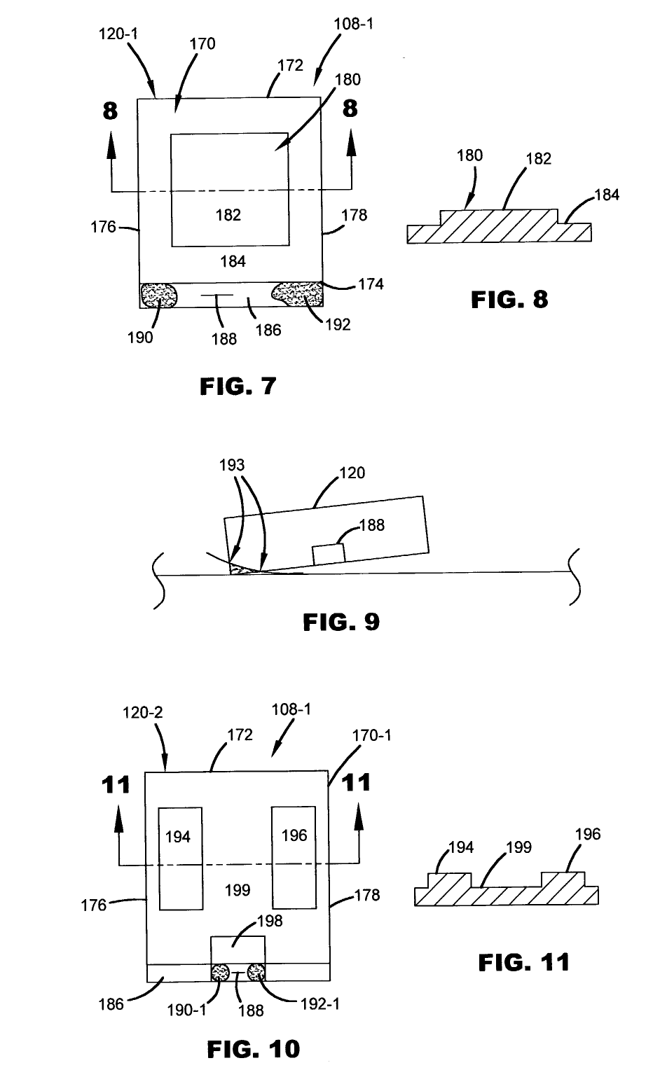

FIGS. 7-8 illustrate an embodiment of a head including a self-adjusting fly height interface. The head includes a slider body 170 having a leading edge 172, a trailing edge 174 and opposed sides 176, 178. The slider body 170 includes an air bearing surface 180 illustrated schematically including a raised bearing surface 182 and a recessed bearing surface 184. The head includes a transducer portion 186 on the trailing edge of the slider body 170. As shown the transducer portion includes transducer elements 188 for read-write operation. As previously described, the head gimbal assembly includes a positive or negative static roll attitude to provide a close point or contact interface proximate to opposed sides 176, 178 of the head spaced from the transducer elements 188.

In the present invention the close point or contact interface of the slider is textured to provide a relatively high wear rate to form a self-adjusting fly height interface. In the illustrated embodiment, the close point or regions for a negative or positive roll attitude proximate to opposed sides of the slider are textured as illustrated schematically at 190, 192 to provide an interface surface having a relatively high wear rate to provide a self-adjusting fly height interface. Head-disc contact between the textured transition or interface 190, 192 provides desired wear to burnish a close portion or interface surface of the head. The burnished portion provides a burnished profile 193 as illustrated in FIG. 9 to transition from a contact regime to a fly height regime.

Typically, the slider body 170 is formed of an Al₂O₃₋TiC material and the transducer portion includes an Al₂O₃ (Alumina) transducer portion encapsulating the transducer elements 188. The textured structure is formed on the relative soft Al₂O₃ portion using interference lithography techniques or laser holography to provide a desired wear rate and a self-adjusting fly height transition. In one embodiment, the transducer portion is fabricated on a wafer (e.g. a Al₂O₃₋TiC wafer) and the wafer is sliced to form slider bars. Air bearing surfaces are fabricated on the slider bars (for example, using a thin film deposition process or other process) and individual sliders are cut from the slider bar to form the head including a slider body and a deposited transducer portion.

FIGS. 10-11 illustrate another embodiment of a textured interface structure for a self-adjusting fly height interface slider where like numbers are used to refer to like parts in the previous FIGS. The slider 120-2 includes a slider body 170-1 including opposed raised bearing rails 194, 196 and a raised center pad 198 elevated above a recessed bearing surface 199. As shown the transducer portion 186 includes textured contact interfaces or close point regions 190-1, 192-1 proximate to opposed sides of the raised center rail 198 to provide a transition region for a self-adjusting fly height interface.

In one embodiment or design where the transducer portion is recessed from the surface of the slider body, the textured region or surface is not formed on an active pressurization area of the air bearing however, application is not so limited. Although a particular air bearing design and textured portion or region is shown in the FIGS., application is not limited to the particular air bearing designs shown or textured regions and alternate bearing designs can be used such a sub-ambient pressure air bearing design including alternate textured interface patterns as described. For example, for an alternate slider embodiment having two rails and spaced transducer elements proximate to the opposed rails, the transducer portion includes a textured transition region proximate to opposed sides of the slider body or close point or region for a positive or negative roll attitude to provide a textured fly height transition region. Although in the illustrated embodiments, the transducer portion includes opposed textured interface surfaces, the transducer portion can include a single textured interface surface for the head depending upon the disc drive application.

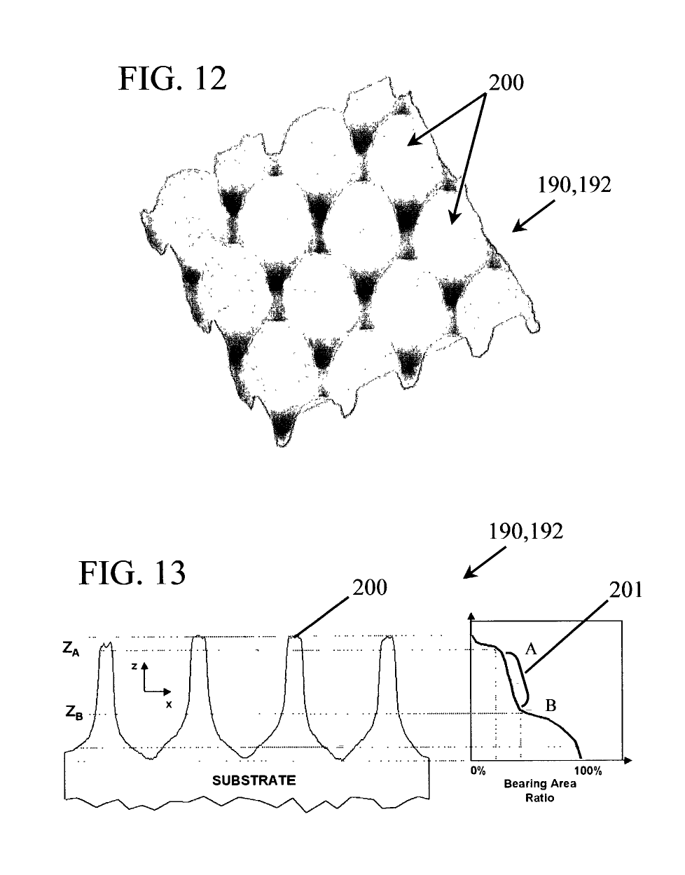

FIGS. 12-13 illustrate embodiments of the textured interface or structure for fly height transition. In the embodiment illustrated in FIG. 12, the textured interface includes a plurality of deterministic bumps or projections 200 to form a micro-textured pattern with a deterministic, spatially coherent surface topography pattern. As shown in FIG. 12, the shape and height of the projections 200 or pattern is designed to provide sufficient wear to wear down to a height or level of interference between the slider and disc surface. In particular, the pattern is designed so that an area of contact in a plateau region 201 of the bumps or contact or bearing area provides low slider friction built-up to limit head crash and accelerated wear to provide desired interface to a fly height regime. In an example embodiment, the contact or bearing area ratio is approximately 26 percent. Thus as described, the textured transition or interface is designed to provide effective mitigation of sharp friction built-up arising from head-disc contact and suitable wear which progresses in a controllable manner to transition from a contact regime to a fly height regime.

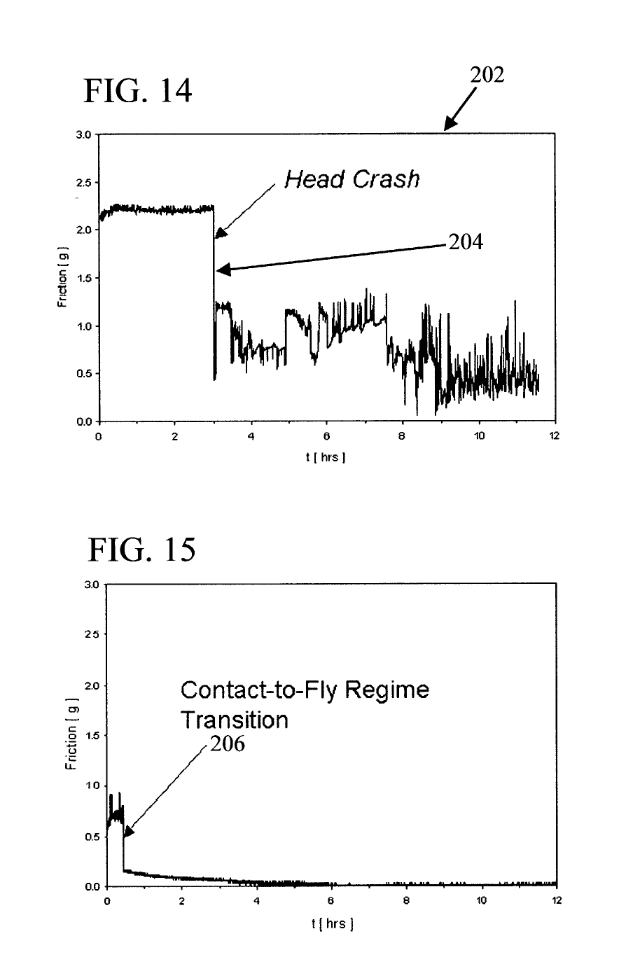

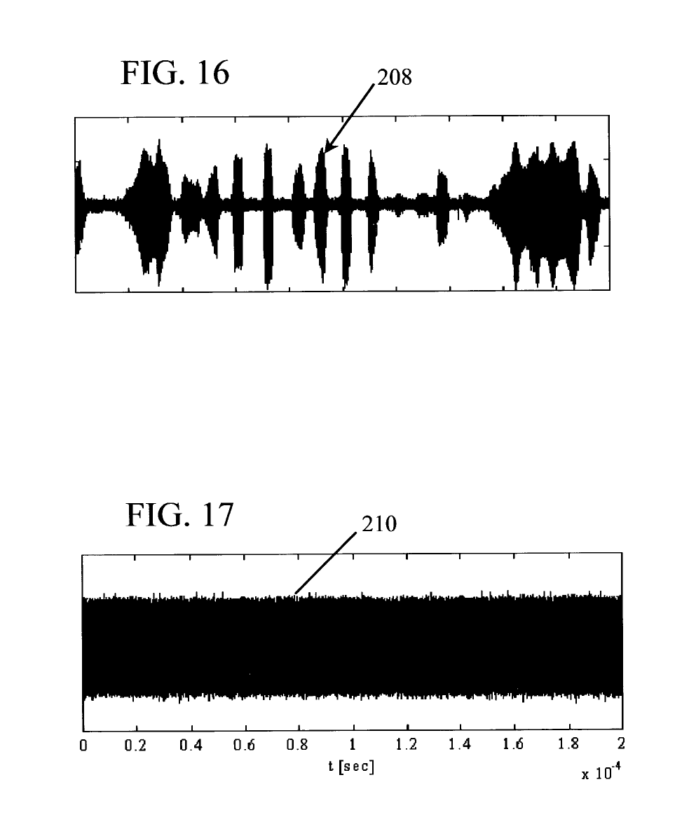

FIG. 14 illustrates a friction profile 202 for a contact regime slider without a textured transition or interface. As shown, contact friction is high causing head crash or failure as illustrated 204 rending the head unusable. In contrast as illustrated in FIG. 15, a head having a textured transition or interface as described has relatively low contact friction and transitions from the contact regime to a fly height regime as illustrated at 206. FIG. 16 illustrates transducer signal 208 for a slider in contact with the disc surface. As shown, contact introduces vibrations in the vertical and cross-track (lateral) directions rendering read-write operations not viable in the contact regime. FIG. 17 illustrates a transducer signal 210 for a transitioned slider in the fly height regime. For practicality, the wear rate of the transition interface should enable contact-to-fly regime transitions to occur during the course of an operating time range of a few seconds up to a minute.

A head for a data storage device including a textured close point or transition region (such as 190, 192) having a suitable wear rate to provide a self-adjusting fly height interface. The textured transition region (such as 190, 192) enables operation in the fly regime for a contact regime slider (such as 166) to limit head crash and increase manufacturing yield.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the preferred embodiment described herein is directed to magnetic recording data it will be appreciated by those skilled in the art that the teachings of the present invention can be applied to other devices such as an optical storage device, without departing from the scope and spirit of the present invention.

What is claimed is:

1. A head comprising:
a slider body having a leading edge, a trailing edge and at least one raised bearing surface and at least one recessed bearing surface; and
a transducer portion having at least one embedded transducer element on the trailing edge of the slider body and the transducer portion including a textured transition region at a close point having a textured surface structure to provide a self-adjusting fly height interface.

2. The head of claim 1 wherein the textured surface structure includes a plurality of micro-textured projections.

3. The head of claim 1 wherein the micro-textured projections are formed in a deterministic pattern.

4. The head of claim 1 wherein the transducer portion is formed of an alumina material and the textured surface structure is formed on the alumina material.

5. The head of claim 1 wherein the textured surface structure provides a fly height transition surface for a contact regime head.

6. The head of claim 1 wherein the head includes one of a positive static roll attitude or a negative static roll attitude and the textured surface structure is formed proximate to a close point for the positive static roll attitude or negative static roll attitude.

7. The head of claim 1 wherein the textured surface structure is formed using interference lithography or laser holography.

8. The head of claim 1 wherein the transducer element is a magnetoresistive transducer element.

9. The head of claim 1 wherein the at least one raised bearing surface includes a center pad and the textured transition region on the transducer portion is proximate to opposed sides of the center pad.

10. The head of claim 1 wherein the transducer portion is fabricated on a wafer which forms the slider body.

11. The head of claim 10 wherein the transducer portion is fabricated using a thin film deposition.

12. A head comprising:
a slider body having a leading edge, a trailing edge and at least one raised bearing surface and at least one recessed bearing surface and a transducer portion having at least one embedded transducer element on the trailing edge of the slider body; and
fly height transition means for providing a transition from a contact regime to a fly height regime.

13. The head of claim 12 wherein the fly height transition means is formed of a textured surface structure proximate to a close point of the head.

14. The head of claim 13 wherein the textured surface structure includes a plurality of micro-textured projections.

15. The head of claim 13 wherein the plurality of micro-textured projections are formed in a deterministic pattern.

16. A method comprising steps of:
rotating a disc to provide an air flow along an air bearing slider; and
burnishing a close portion of the slider to transition the slider from a contact regime to a fly height regime.

17. The method of claim 16 wherein the step of burnishing a close portion of the slider provides a burnished profile to transition the slider from the contact regime to the fly height regime.

18. The method of claim 16 and further comprising the step of:
providing a positive or negative static roll attitude and wherein the step of burnishing burnishes the slider at a positive or negative close point.
